(19) United States
(12) Patent Application Publication
(10) Pub. No.: US 2015/0129472 A1
(43) Pub. Date: May 14, 2015

(54) Fiber Mats Coated with Nanogrid Visible Spectrum Photocatalysts

(71) Applicants: Pelagia-Irene Gouma, Port Jefferson, NY (US); Jusang Lee, Coram, NY (US)

(72) Inventors: Pelagia-Irene Gouma, Port Jefferson, NY (US); Jusang Lee, Coram, NY (US)

(21) Appl. No.: 14/128,742

(22) PCT Filed: Jun. 27, 2012
(86) PCT No.: PCT/US2012/044327

§ 371 Date: Dec. 4, 2014

Related U.S. Application Data
(60) Provisional application No. 61/501,436, filed on Jun. 27, 2011.
(60) Provisional application No. 61/544,122, filed on Oct. 6, 2011.

(51) Int. Cl. C02F 1/68; C02F 1/72; C02F 1/32; D04H 1/4258; D01D 5/00; B01J 23/888; B01J 31/34; B01J 37/34; B01J 35/06; C02F 1/28; B09C 1/00

(52) U.S. Cl. CPC C02F 1/681; C02F 1/286; C02F 1/725; C02F 1/32; D04H 1/4258; B09C 1/00; B01J 23/888; B01J 31/34; B01J 37/342; B01J 35/06; D01D 5/003; C02F 2103/007
USPC 210/170.01; 210/691; 442/159; 405/128.45; 252/175; 252/178; 252/181; 264/465

(57) ABSTRACT

Cellulose acetate or polyvinylpyrrolidone is electrospun into fibers having diameters of nanometer scale to form a first mat that is capable of absorbing hydrocarbons. A second mat may be formed from a solution of cellulose acetate or polyvinylpyrrolidone further containing tungsten trioxide. The solution is electrospun onto a copper mesh and then thermally oxidized to create a nanostructure comprising a grid or network of tungsten trioxide crystals and copper oxide crystals. The nanogrid is capable of photocatalyzing the degradation of hydrocarbons to carbon dioxide and water. The grid may be combined with the first mat to degrade hydrocarbons that the first mat absorbs.

### PRIORITY

This application claims priority to U.S. Provisional Patent Application Ser. No. 61/501,436, filed on Jun. 27, 2011, and Ser. No. 61/544,122, filed on Oct. 7, 2011.

### GOVERNMENT SUPPORT

The present invention was supported in part by the National Science Foundation under contracts DMR 1046599, 1106168, and 1156513. The government has certain rights in the invention.

### FIELD OF INVENTION

The present invention relates to electrospun mats comprising nanofibers, including mats of cellulose acetate nanofibers and their use in hydrocarbon recovery from aqueous environments, and compositions and methods for oxidatively degrading hydrocarbons using ceramic nanostructures that are photocatalytic when disposed in a grid-like configuration, or nanogrid. In particular, nanogrids disposed on or near the surface of electrospun mats of hydrocarbon-absorbing nanofibers are used to remove oil from the surface of a body of water.

### BACKGROUND

Because cellulose acetate can be derived from wood pulp and because sunlight readily degrades it, the material is regarded as a relatively inexpensive and “environmentally friendly” polymer. It is insoluble in water, but is hydrophilic (“wettable”). It is also slightly hydrophobic, so it attracts petroleum and other hydrocarbons (i.e., it is “oleophilic”). Cellulose acetate in various forms has been proposed for absorbing hydrocarbons layered on the surface of a body of water. Porte, in U.S. Pat. No. 3,990,970, mentioned cellulose acetate in this connection but did not test it. Instead, he experimented with a “pulp” form of polyhexamethylene adipamide, which, like cellulose acetate, is also wettable and oleophilic. To keep the adipamide pulp from absorbing water (whereupon it will absorb almost no oil), Porte was obliged to coat the polymer with a water-repellent but oleophilic material (paraffin).

Mats or sheets of oil-absorbent material constructed from fibers are advantageous in some applications because the material can be laid down as a “blanket” over an oily surface and later removed (with its absorbed oil) more or less intact. Alternatively, such mats can be modified to include a suitable means, advantageously a photocatalytic means, of degrading the absorbed oil in situ. Cellulose acetate fibers, suitably treated to suppress their hydrophilicity, have been employed to fabricate mats for oil absorption (U.S. Pat. No. 4,102,783 to Zenno et al.). What is needed, however, is a readily fabricated, oil-absorbing mat comprising cellulose acetate or other fibers that require no chemical pre-treatment to achieve acceptable hydrophobicity. Also needed is a more efficient means of degrading hydrocarbons, advantageously combined with the mat to facilitate cooperation between the absorptive process and the degradative process.

Chemical bonds in a compound may be disrupted by heat or by disturbances induced in the electronic configuration of the bonds by the energy of light impinging on the compound. In the presence of oxygen, photo-oxidation may obliterate the carbon-hydrogen and carbon-carbon bonds of hydrocarbon molecules, leaving only carbon dioxide and water. Direct photolysis, or photodecomposition, is well-known, as is photocatalysis. The latter typically exploits the semiconducting properties of a metal or metal oxide such as TiO₂. Here, light of sufficient energy impinging on the metal can “lift” (in a quantum mechanical sense) an electron from the metal's valence band into its conduction band. In that excited condition, the surface of the metal can induce protons and hydroxy free radicals to form and disrupt the electronic configuration of chemical bonds of nearby hydrocarbon molecules to yield carbon dioxide and water or, at least, more readily biodegradable organics.

The quest for efficiency in hydrocarbon degradation has led the art in general, and the applicants in particular, to seek less expensive and more energy-efficient alternatives to TiO₂, to extend the range of frequencies in the visible spectrum to which the catalyst is sensitive, and to maximize the extent of contact between molecules to be degraded and the catalyst's surface.

### SUMMARY OF THE INVENTION

In one embodiment, the invention provides a system comprising a) an oil-contaminated surface of a body of water; b) a chemically untreated non-woven mat comprising nanofibers, optionally in combination with a photocatalytic nanogrid, and c) a means of disposing said mat on said surface. In one embodiment, said mat comprises nanofibers having a diameter of more than about 10 nm and less than about 5 μm, preferably less than about 1,000 nm, more preferably less than about 500 nm.

In one embodiment, said nanofibers are formed by an electrospinning process. In one embodiment, said nanofibers are electrospun under conditions such that said nanofibers adhere to a backing material or to nanofibers already adherent to said backing material to create backing-adherent nanofibers. In one embodiment, said adherent nanofibers form a non-woven, untreated mat comprising said nanofibers. In one embodiment, said nanofibers and said mat do not adhere to said backing material. In a preferred embodiment, said mat is removably adherent to said backing material. In one embodiment, said mat is more than about 50 nm thick and less than about 25 cm thick, preferably more than about 1 mm thick, and more preferably more than about 1 cm thick.

In one embodiment, said mat, in the presence of water, with or without a contaminating oil, retains a density less than the density of water at or near standard pressure and temperature for at least 30 minutes.

In another embodiment, the invention provides a product comprising an untreated, non-woven mat comprising nanofibers, wherein said mat further comprises an oil absorbed from an oil-contaminated surface of a body of water.

In still another aspect, the invention provides a method of removing an oil from a surface contaminated with oil, the method comprising disposing untreated, electrospun nanofibers comprising cellulose acetate onto said contaminated surface such that said oil is adsorbed on said nanofibers to create oil-coated nanofibers, and removing said oil-coated nanofibers from said surface to remove said oil from said surface. In one embodiment, said nanofibers are disposed on said contaminated surface to form a mat. In one embodiment, said mat is formed in situ. In another embodiment said mat is pre-formed. In one embodiment, said pre-formed mat adheres to a backing material. In another embodiment, said pre-formed mat lacks backing material. In one embodiment, said mat absorbs said oil, creating an oil-containing mat. In one embodiment, said oil-containing mat is removed from said contaminated surface to remove said oil from said surface. In one embodiment, said oil-containing mat is secured in a container such that said oil is isolated. In one embodiment, said surface comprises water. In one embodiment, said water comprises a body of water. In one embodiment, said water is sea-water. In one embodiment, said water is fresh- or brackish water. In another embodiment said surface is on land. In still another embodiment, said surface is a man-made surface.

In one embodiment, said oil comprises an emulsion. In one embodiment, said emulsion is a water-in-oil emulsion. In another embodiment, said emulsion is an oil-in-water emulsion.

In another aspect, the invention provides a method of recovering said oil, the method comprising the steps of a) disposing a non-woven mat of untreated, electrospun nanofibers comprising cellulose acetate onto a surface contaminated with oil to absorb said oil; b) removing said mat from said contaminated surface; c) securing said mat in a container, d) expressing said absorbed oil from said mat, and e) isolating said expressed oil.

In one embodiment, the invention provides a photocatalytic nanogrid. In a preferred embodiment, said nanogrid and said mat are cooperatively combined. In one embodiment, said nanogrid comprises a composite of cupric oxide (CuO) and tungsten trioxide (WO₃). In another embodiment, said nanogrid comprises a composite of crystalline CuO and crystalline WO₃. In a preferred embodiment, said composite comprises said CuO crystals and said WO₃ crystals disposed in a 1:1 relationship to one another. In one embodiment, a CuO crystal contacts a WO₃ crystal. In one embodiment, said composite comprises a bicrystal. In one embodiment, said bicrystal comprises crystalline CuO and crystalline WO₃. In one embodiment, said crystalline CuO is disposed in a copper mesh. In one embodiment, said composite floats on and covers a liquid surface. The liquid includes, without limitation, an aqueous liquid and a hydrocarbonaceous liquid or oil.

In another aspect, the invention provides a method of fabricating a composite comprising CuO and WO₃, said method comprising the steps of:
a) providing a solution comprising tungsten isopropoxide in water;
b) hydrolyzing said tungsten isopropoxide to create a sol-gel comprising WO₃;
c) mixing said sol-gel with acetic acid and ethanol under hypoxic conditions;
d) adding said mixture to polyvinyl pyrrolidone (PVP) in ethanol to create a WO₃-PVP-solvent mixture;
e) electrospinning said mixture, with solvent evaporation, onto a copper mesh to create a three-dimensional network of WO₃-PVP nanofibers on said copper mesh, and
f) thermally oxidizing said PVP and said mesh to create said composite.

In one embodiment, said composite is created on a surface of said mat. In another embodiment, the electrospinning of said mat and said WO₃-PVP-solvent mixture occur at substantially the same time.

### DEFINITIONS

To facilitate understanding of the descriptions herein of embodiments of the invention, a number of terms (set off in quotation marks in this Definitions section) are defined below. Terms defined herein (unless otherwise specified) have meanings as commonly understood by a person of ordinary skill in the areas relevant to the present invention. As used in this specification and its appended claims, terms such as “a”, “an” and “the” are not intended to refer to only a singular entity, but include the general class of which a specific example may be used for illustration, unless the context dictates otherwise. The terminology herein is used to describe specific embodiments of the invention, but their usage does not limit the scope of the invention, except as outlined in the claims.

The phrase “chosen from A, B, and C” as used herein, means selecting one or more of A, B, C.

As used herein, absent an express indication to the contrary, the term “or” when used in the expression “A or B,” where A and B may refer to a composition, object, product, etc., means one or the other (“exclusive OR”), or both (“inclusive OR”). As used herein, the term “comprising” when placed before the recitation of steps in a method means that the method encompasses one or more steps that are additional to those expressly recited, and that the additional one or more steps may be performed before, between, and/or after the recited steps unless specifically stated otherwise. For example, a method comprising steps a, b, and c encompasses a method of steps a, b, x, and c, a method of steps a, b, c, and x, as well as a method of steps x, a, b, and c. Furthermore, the tetin “comprising” when placed before the recitation of steps in a method does not (although it may) require sequential performance of the listed steps, unless the context dictates otherwise. For example, a method comprising steps a, b, and c encompasses, for example, a method of performing steps in the order of steps a, c, and b, the order of steps c, b, and a, and the order of steps c, a, and b, etc.

Unless otherwise indicated, all numbers expressing quantities in the specification and claims are to be understood as being modified in all instances by the term “about.” Accordingly, unless indicated to the contrary, the numerical parameters in the specification and claims are approximations that may vary depending upon the desired properties sought to be obtained in a particular embodiment of the present invention. At the very least, and without limiting the application of the doctrine of equivalents to the scope of the claims, each numerical parameter should be construed in light of the number of reported significant digits and by applying ordinary rounding techniques. Any numerical value, however, inherently contains deviations that necessarily result from the errors found in the numerical value's testing measurements.

Measures of length include the meter (“m”), centimeter (“cm”), which is 1/100 of a meter, the millimeter (“mm), which is 1/1,000 of a meter, the micron or micrometer (μm), which is 1/1,000,000 of a meter, and the nanometer (“nm”), which is 1/1,000,000,000 of a meter.

The term “not” when preceding, and made in reference to, any particularly named entity or phenomenon means that only the particularly named entity or phenomenon is excluded. It is to be understood that naming an entity or phenomenon herein provides basis for of its inclusion or its exclusion as an element of any embodiment. The term “not pre-treating” herein refers, for example, to nanofibers not treated chemically to suppress their hydrophilicity prior to their exposure to water.

The term “altering” and grammatical equivalents as used herein in reference to any entity and/or phenomenon refers to an increase and/or decrease in the quantity of the entity in a given space and/or the intensity, force, energy or power of the phenomenon, regardless of whether determined objectively, and/or subjectively.

The terms “increase,” “elevate,” “raise,” and grammatical equivalents when used in reference to the quantity of an entity and/or the intensity, force, energy or power of a phenomenon in a first sample relative to a second sample, mean that the quantity of the entity and/or the intensity, force, energy or power of the phenomenon in the first sample is higher than in the second sample by any amount that is statistically significant using any art-accepted statistical method of analysis. The increase may be determined subjectively, for example when a subject refers to his subjective perception, such as pain, clarity of vision, etc. The quantity of a substance and/or phenomenon in a first sample may be expressed relative that quantity in a second sample (e.g., a substance and/or phenomenon is at least 10% greater than the quantity of the same substance and/or phenomenon in a second sample). Alternatively, a difference may be expressed as an “n-fold” difference.

The terms “reduce,” “inhibit,” “diminish,” “suppress,” “decrease,” and grammatical equivalents when used in reference to the quantity of an entity and/or the intensity, force, energy or power of a phenomenon in a first sample relative to a second sample, mean that the quantity of an entity and/or the intensity, force, energy or power of a phenomenon in the first sample is lower than in the second sample by any amount that is statistically significant using any art-accepted statistical method of analysis.

As used herein, a “mat” encompasses objects extending in two dimensions and having finite thickness in a third dimension, ranging from the thickness of a film (microns) to that of a cube or, in some cases, to a thickness even greater than the extent of the mat in at least one of its two other dimensions. The mats contemplated herein for use as oil absorbers preferably comprise fibers of, or formed from, cellulose acetate, but are not limited to such fibers. For example, in some embodiments herein, mats comprising nanofibers formed from polyvinylpyrrolidone are preferred. In any case, the fibers making up the mats are not woven, that is, they do not comprise a fabric in the sense of a material made by organizing the fibers into warp threads and weft threads. The mats are “non-woven” but comprise nanofibers that cross one another with some frequency to form a mesh-like “network” of fibers. The mats may therefore have substantial structural integrity and resilience, such that they may be reversibly stretched, compressed, bent or folded. The size of the mats (length, width, thickness) is application-specific, and not intended to be a limiting factor herein.

“Cellulose acetate” refers to any esterified cellulosic polymer (which may also be referred to herein as a “polymer of glucose” or “polysaccharidic”), natural or synthetic, esterified preferably with acetic acid but without excluding other esterifying groups such as propionate or butyrate. In general, the cellulose acetates used herein are “untreated” in the sense that no provision is made to chemically alter the hydrophilicity of cellulose acetate. The term “untreated” is not intended, however, to preclude processing of the fibers or the mats from which they are made for other purposes. Thus, the nanofibers or the mats from which they are made may contain (by way of example and not of limitation) metals, metal oxides, organic or inorganic dyestuffs, etc. The mats may comprise other structural elements such as threading or wire to improve the structural integrity of the mat, for example. Other incorporated elements may provide sensing means, locator means, means of identification, indicator means to determine water- or oil-saturation, etc.

“Tungsten isopropoxide” is an alkoxylated form of tungsten, preferred herein for use as a source of WO₃ in the manufacture of nanogrids. Other methods of generating WO₃, including but not limited to acid treatment of scheelite or calcination of ammonium paratungstenate, are within the scope of relevant embodiments of the invention.

“Hypoxic” refers to a condition wherein the concentration of oxygen is insufficient to substantially affect a chemical reaction. A reaction conducted in an aqueous solution under nitrogen, for example, occurs under hypoxic conditions.

A “copper mesh” refers herein to any network, woven or non-woven, of copper rods, tubes or ribbons wherein the rod-, tube- or ribbon structures define voids therebetween.

“Thermal oxidation” refers herein to a heat-treating process, typically carried out in a furnace in the presence of oxygen, wherein the surface of the treated material becomes oxidized.

A feature of the fibers used in the several embodiments of the invention is their diameter, which is constrained substantially to the nanometer scale (1-1,000 nm). Although it is not necessary to provide an explanation of why embodiments of an invention work differently from other structures, it is thought that the distribution of electrostatic charges on the nanofibers comprising the mat embodiments of the present invention, together with the lattice-like structure that the nanofibers generate, create surface tension effects that are different from assemblies comprising larger, non-spun fibers, such that the electrospun nanofibrous mat does not become water-logged. It will be understood that embodiments may include some larger fibers without interfering with the advantages that the nanofibers confer. Electrospinning, besides its possible other advantages, is a particularly convenient way of fabricating fibers having nanoscale diameters. As used herein, the terms “electrospun,” electrospin,” and “electrospinning” are used interchangeably and refer to the process patented by Formahls in 1934 (U.S. Pat. No. 1,975,504 incorporated herein in its entirety).

Mats may be formed by depositing electrospun fibers on a “backing material,” the choice of which is not intended to be limiting herein, but will be determined by the intended use of the mat, taking into consideration such factors as solubility in water or hydrocarbons, resiliency, strength, flexibility, etc. Depending on intended use, a backing material may be selected for its tendency to adhere to electrospun cellulose acetate nanofibers (such that the mat is “adherent” to the backing). Alternatively, a backing material may be selected such that the mat is “removably adherent” to it to one degree or another. In one embodiment, the mat may be stripped from the backing by applying mechanical force. In one embodiment, a “slip layer” may be interposed between the mat and the backing such that when water is allowed to penetrate the backing, the slip layer dissolves or “gives way” or “loosens” to release the mat so that it “slips” from the backing. Alternatively, in some embodiments, the slip layer may be loosened by oil or by organic solvents. As another alternative embodiment, the backing may be chosen such that the mat forms on the backing without adhering to it at all. In still another embodiment, the mat may be formed by electrospinning directly on the surface that the mat is intended to treat, without any interposing backing layer. In this case, there is no need for a “pre-formed” mat. That is, the mat can be formed in situ by means of an electrospinning apparatus suspended from a boom or other support or from an airborne vehicle, for example. In another aspect, the “backing material” may comprise a nanogrid as described and claimed herein.

In some embodiments, electrospinning is a preferred method of laying down a mat of non-woven nanofibers for use as a template in which to fabricate nanogrids. The term “nanogrid,” as used herein, refers to an interconnected but “open” or “porous” network of nanoscale structures such as rods, tubes, or ribbons having an aspect ratio greater than 1. The nature of the contact at connection points is not intended to be limiting, nor is the distance between any two points of connection or the area or volume of any void defined by interconnecting structures.

The term “crystal,” as used herein, refers to any collection of atoms, molecules or ions arranged in ordered repetition to form a solid. The term “composite” herein refers to a material comprising at least two distinguishable materials, whether or not disposed with respect to one another in any particular order or proportion.

The composition of the interconnecting nano-structures is also not intended to be limiting, but specific embodiments herein comprise crystalline materials wherein individual crystals in a rod, tube or ribbon tend to make contact with one another. In particular embodiments, crystals of CuO and WO₃ tend to “line up” to form the individual rods, tubes or ribbons that comprise the nanogrid. Although it is not necessary to propose any particular mechanism to explain an embodiment of an invention, it is likely that this “clustering-in-line” is a consequence of the method of manufacture, described below. With some frequency, a crystal of CuO in the line contacts a crystal of WO₃. This arrangement may be referred to herein as a “bicrystal.” Again, it is not necessary to propose a mechanism by which an embodiment of an invention works, but the term “bicrystal” is used because it is thought that the properties of the two types of crystal, together with their proximity, create a photocatalytic crystalline system, wherein surface effects of the CuO crystal on hydrocarbon molecules conspire with the free radicals (hydroxyl and protonyl) that light-activated WO₃ crystals create to rapidly degrade hydrocarbon to CO₂ and water.

Nanogrids are “self-supporting” in the sense that they form stable, mesh-like structures that float, intact, on liquid surfaces, whether the liquid be aqueous or oleaginous.

The term “sol-gel” refers herein to a solution which, under appropriate circumstances, can form a gel and, when conditions allow, can revert to a solution.

It will be understood that the term “oil” is used herein generically to mean any liquid or liquefied substance or substances which tend to float on water. More generally, the term is intended to encompass any hydrocarbonaceous material disposed on a surface, such as an area of land, a stony surface, etc. The surface, furthermore, may be man-made. Non-limiting examples include cement or concrete floors and other surfaces such as streets and sidewalks, asphalt surfaces, tiled, bricked or composite surfaces, and wooden surfaces.

The term “oil” is also intended to encompass emulsified oils, including emulsions wherein droplets of oil are surrounded by water (an “oil-in-water” emulsion) and the reverse (a “water in oil” emulsion), without regard to the presence or absence of emulsifiers, detergents, surfactants, etc.

As used herein, no particular distinction is intended between the terms “adsorb” and “absorb” in relation to the phenomenon of a “mat” taking up oil or hydrocarbonaceous substances. Any mat that takes up oil, by whatever mechanism, when in use for the intended purpose of taking up oil, is an “oil-containing” mat that comprises “oil-coated” nanofibers. Oil-containing mats can be “removed” in a number ways including, without limitation, physically lifting, towing, netting, or vacuuming up the mat, or burning it. To “secure” an oil-containing mat, one can deposit it in a barrel or tank, surround it with booms (optionally, without moving it), etc. Any such means of securement is, herein, a “container” as long as it creates a condition wherein the oil or a portion of it is separated (“isolated”) from the environment it had been contaminating, which environment can be any site having in or on it a contaminated surface such as the ones cited above, or a body of water (sea-, fresh- or brackish) having a contaminated surface. As used herein, the term “contaminate” and its cognates refers to an impurity, whether natural or manmade, that is undesirable and/or might be toxic to life.

### BRIEF DESCRIPTION OF THE DRAWINGS

FIG. 1 is a scanning electron micrograph of cellulose acetate nanofibers.

FIG. 2 is a photograph of a cotton ball (left foreground) and a cellulose acetate mat (right foreground).

FIG. 3 is a photograph of a cotton ball (left panel) that was placed atop a body of water contaminated with blue-dyed benzene, which sank, and a cellulose acetate mat (right panel) similarly placed atop a body of water contaminated with blue-dyed benzene, which stayed afloat.

FIG. 4 is a photograph of the cotton ball (left foreground) recovered from the vial shown in the left panel of FIG. 3 (left background), and the cellulose acetate mat (right foreground) recovered from the vial shown in the right panel of FIG. 3 (right background).

FIG. 5 is a scanning electron micrographic image of a synthesized tungsten trioxide/cooper oxide nanostructure, or nanogrid, having photocatalytic properties.

FIG. 6 is a transmission electron micrographic image of the nanogrid of FIG. 5, at a magnification to permit resolution of tungsten trioxide and copper oxide crystals.

FIG. 7 compares a sample of dyed benzene, (a), to a sample degraded by photocatalysis using tungsten trioxide/copper oxide nanograds, (b), and a sample degraded photocatalytically using TiO₂.

FIG. 8 shows differential scanning calorimetry traces of polyvinylpyrrolidone (PVP), PVP deposited by electrospinning onto a copper mesh, and tungsten trioxide dissolved in PVP.

### DETAILED DESCRIPTION OF THE INVENTION

Electrospinning is a well-known method of fabricating thin threads or fibers from dissolved polymers. In one embodiment, the polymer solution (the “precursor” of the nanofibers) is expressed from a syringe driven by a syringe pump. The solution is forced through a hollow needle and exits as tiny droplets. Each droplet immediately traverses a field of high voltage. The potential applied to the solution as it emerges from the needle-tip induces an accumulation of charges on the surface of the droplet, which changes the surface tension of the droplet, causing the surface to “break” such that the droplet becomes a jet-stream of charged fibers that can be collected as a charged active matrix, which can build up to form a mat (Bishop et al. 2007; Bishop et al. 2005; Sawicka et al. 2006; Gouma “Sensor Materials—US-Japan Workshop 2004; Haynes et al. 2008; Haynes PhD Dissertation, “Electrospun Conducting Polymer Composites for Chemo-Resistive Environmental and Health Monitoring Applications,” 2008; each of which is herein incorporated by reference in its entirety, together with U.S. Pat. No. 7,592,277 to Andrady et al.

Any surface that is “at ground” relative to the potential on a droplet whose surface has just been charged in an electric field can serve as a “collector” for the spun fibers. This provides an opportunity to fabricate oil-absorbing mats in situ.

Adjustments to the properties of the electric field, the concentration of polymer in the precursor solution, the solvent and the polymer used, the pressure and flow-rate of the precursor solution from the needle tip, the distance from needle-tip to collection surface, and ambient conditions (temperature, pressure, ambient gases) allow persons of skill in the art to generate fibers of pre-determined thickness at pre-determined rates to build up mats of predetermined density, porosity and thickness. U.S. Pat. No. 7,901,611 to Wincheski, incorporated herein in its entirety for all purposes, is exemplary.

Nanofiber diameters ranging from about 1 micrometer to about 1 nanometer may be useful in certain embodiments of the invention. Generally, a range from about 1 micrometer to about 10 nanometers is preferred. A range from about 50 to 500 nanometers is more preferred, and a range from about 100 to 300 nanometers is most preferred. An environment of air comprising gases at about standard partial pressures and temperatures (0-30° C.) is suitable for generating the nanofibers used in embodiments of the invention, but higher temperatures, such as those used for thermoset processes, are not to be excluded. Neither are non-standard mixtures of air gases, or gases not normally present in air, or non-standard pressures.

As noted above, the hydrophilicity of cellulose acetate and other cellulosic fibers such as cotton promotes water uptake and a concomitant reduction in oleophilicity, together with loss of buoyancy. Accordingly, cellulosics tend not to be used to remove oil from water unless they are first treated to substantially increase their hydrophobicity (U.S. Pat. No. 3,667,982 to Marx; U.S. Pat. No. 6,852,234 to Breitenbeck; U.S. Pat. No. 7,544,635 to Liang et al.). Surprisingly, the inventors have found that no such treatment is required of the forming nanofibers, the spun nanofibers, or the nanofiber mats to create a buoyant product that does not become waterlogged before it can take up hydrocarbonaceous liquids. This fact obviates all need to consider the expense of substance(s) used to treat, the complexity of the treatment, and the environmental or public health implications of the treatment.

Photocatalytic decomposition of organic pollutants in water is receiving increased attention in recent years because of its reliance on solar energy. Specifically, n-type semiconductors, such as titania (TiO₂), when illuminated with light having a higher energy than the semiconductor's band gap, are capable of decomposing organic compounds (Nair et al., 1993). Crude oil consists primarily of hydrocarbons, such as alkanes (e.g. butane, pentane), cycloalkanes, and aromatic hydrocarbons (benzene, toluene). Photocatalytic oxidation of crude oil on salt water has been studied by Heller's group (Nair et al., 1993) who used titania pigment for these studies. Titania as a photocatalyst absorbs and is excited by light of wavelengths shorter than 387 nm for the anatase polymorph having a 3.2 Å bandgap (Nair et al., 1993).

The underlying physical chemistry of oil decomposition, as explained in detail in reference (Nair et al., 1993) and as presented below, involves the generation of an electron-hole pair for each absorbed photon (i.e. an electron moving from the valence to the conduction band leaving a hole or “electron vacancy” in the former as presented in equation 1:

hv→e⁻+h (1)

The diffusion of the hole to the titania particle's surface, upon reaction with an adsorbed water molecule, produces an OH radical and a proton (see equation 2):

H⁺+H₂O→H⁺+HO. (2)

Equation 3 explains how charge neutrality is maintained during this process (resulting in the production of hydrogen peroxide):

2e⁻+2H⁺+O₂→H₂O₂ (3)

Part of the peroxide may decompose (see equation 4)

2H₂O₂→2H₂O+O₂ (4)

The hydroxyl radicals then initiate the oxidation of hydrocarbon to carbon dioxide, water, and water-soluble organics (aldehydes, ketones, phenolates, carboxylates) products that may “rapidly biodegrade by marine bacteria” (Nair et al., 1993), for example see equation 5,

RCH₂CH₂R′+→.OH→R^{Ċ}HCH₂R′+H₂O (5)

through photocatalytic oxidation, which has been defined as“a free-radical catalyzed thermodynamically spontaneous process . . . that proceeds at ambient temperature” (Nair et al., 1993). Titania photoassisted oxidation eliminates polycyclic aromatic hydrocarbons (some of which are known carcinogens) and also phenols (products of natural photo-oxidation) that further decompose to polymeric tars that are difficult to biodegrade (Nair et al., 1993). Thus, oxide-based photoassisted oxidation is a most promising route to effective and eco-friendly oil decomposition.

The efficiency of the photocatalytic oxidation of anatase particles (UV collectors) is reduced by electron-hole recombination and water formation, which slows the rate of solar assisted oxidation (Nair et al., 1993). However, “approximately 96.0-97.0% of the sea-level solar irradiance consists of photons that are not sufficiently energetic to promote valence band electrons to the conduction band of TiO₂ (anatase)” air et al., 1993). For this reason, embodiments of the current invention use oxide photocatalysts that absorb in the visible range of solar radiation to improve cleaning efficiency in terms of oil decomposition rate and fast response.

WO₃ is a visible-light-responsive photocatalyst for oxygen generation, and has a valence band potential similar to that of titania, suggesting that the “oxidative ability of a hole on the WO₃ valence band is almost the same as that on TiO₂” (Chai et al, 2006). However, it is known that WO₃ exhibits poor activity as far as the decomposition of organic compounds is concerned (Chai et al, 2006). While Pd and Pt are effective as co-catalysts for the complete photo-degradation of organic compounds under visible light, they are too expensive to be practical for use in environmental remediation.

Cupric oxide (CuO) has been considered as an economical and easy to make alternative for the noble metal co-catalysts (Chai et al, 2006) but the art teaches (Arai et al, 2009) that, in order for CuO to enhance the photocatalytic activity of WO₃, the particles of the different oxides need to be in contact with each other. This is impossible to achieve to any useful effect by mixing the powders alone. Surprisingly, the inventors have found that such contact—a virtual “bicrystal” of CuO and WO3—can be created by methods disclosed herein.

Embodiments of the invention combine two synthesis methods to form novel 3D nanogrids of a CuO/WO3 system that performs as a bicrystal. WO₃ sol-gel—polymer, (preferably either cellulose acetate (CA) or polyvinylpyrolidone (PVP), is deposited on Cu grids by means of electrospinning, followed by thermal treatment; the latter step oxidizes Cu to CuO while crystallizing the amorphous WO₃ so as to form crystalline WO₃ particles. The resulting structure consists of self-supported 3D mats of a 1:1 WO₃ and CuO particle configuration in a “photocatalytic screen” or “net” of high aspect ratio and an extremely high surface area for surface-driven reactions. The “nanofibers” comprising the network are lined up clusters of metal oxides but they create a structure that is easy to handle and is strong enough to sustain vibrations and shaking, and stable enough to prevent particle dissolution in (salt) water environments.

### EXPERIMENTAL

These examples present representative protocols used in describing the invention disclosed herein. These protocols are not to be considered limiting as any analogous or comparable protocol measuring the same end-points within the skill of an ordinary artisan would also be sufficient.

### Example 1

### Precursor Solution and Electrospinning

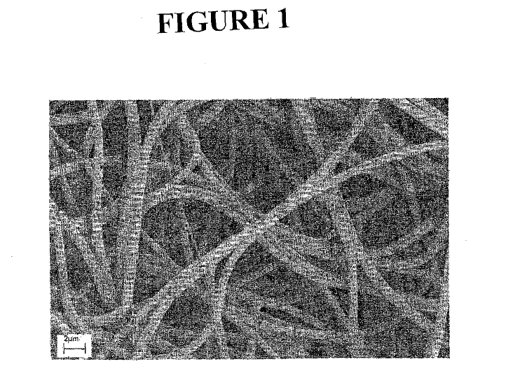

Cellulose Acetate (MW=˜29,000) precursor solution (15 wt %) was prepared in 4:6 acetic acid: acetone mixture with 1 hour of ultrasonication. Electrospinning was carried out using a 10 ml syringe with a 20 gauge stainless steel needle at applied voltage 19 kv over a distance of 15 cm. The syringe pump was set to deliver the solution at a flow rate of 9.6 ml/h and all the spinning was carried out at ambient condition. FIG. 1 is a scanning electron microscopy (SEM) image of the deposited nanofibers.

### Example 2

### Oil-Absorbing Mats

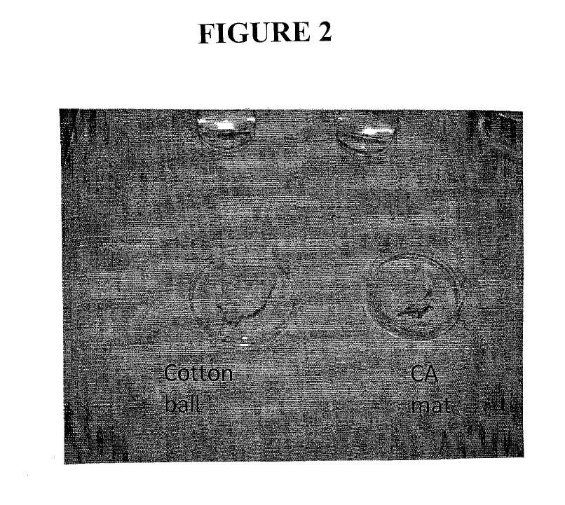

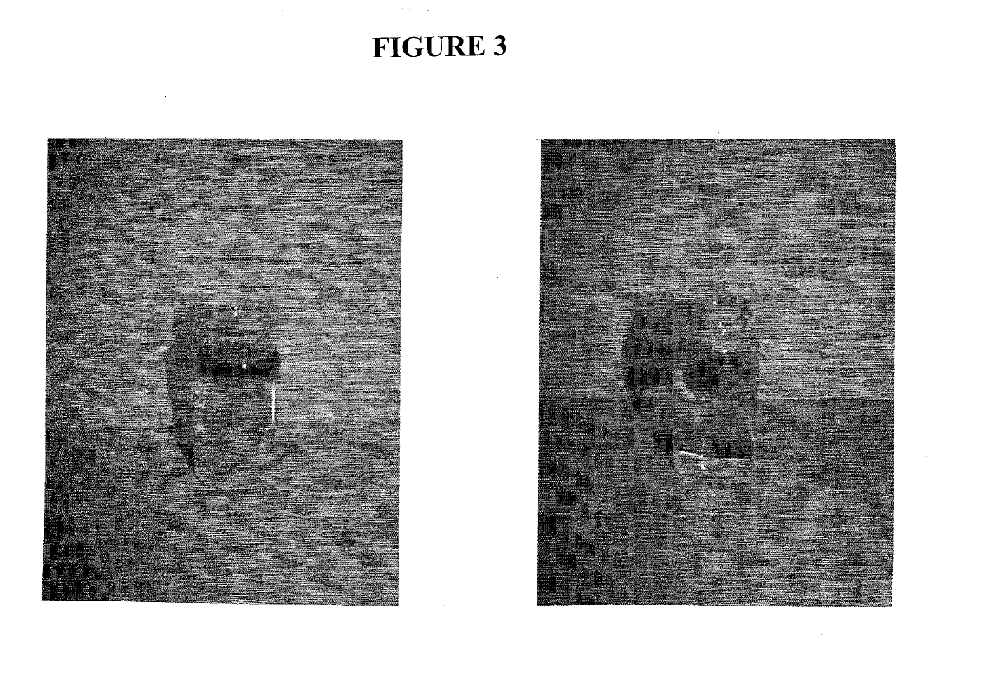

FIG. 2 is a photograph of an ordinary cotton ball (on left) and a cellulose acetate mat (on right) weighing about half as much as the cotton ball. Benzene was dyed with Unisol blue AS to help visualize the absorption activity of the cellulose acetate mats. Two ml of dyed benzene solution was mixed with 10 ml of water in two vials (FIG. 3). Approximately 0.4 g of cotton was floated atop the benzene and water mixture at left. Approximately 0.2 g of matting was floated atop the benzene and water mixture at right. The cotton rapidly sank through the benzene layer into the water below. The matting instantly soaked up the benzene, remained afloat, and held the benzene as shown in the right panel of FIG. 3.

### Example 3

### Cellulosic Fiber (“Cotton Ball”) Vs. Cellulose Acetate Nanofiber Mat

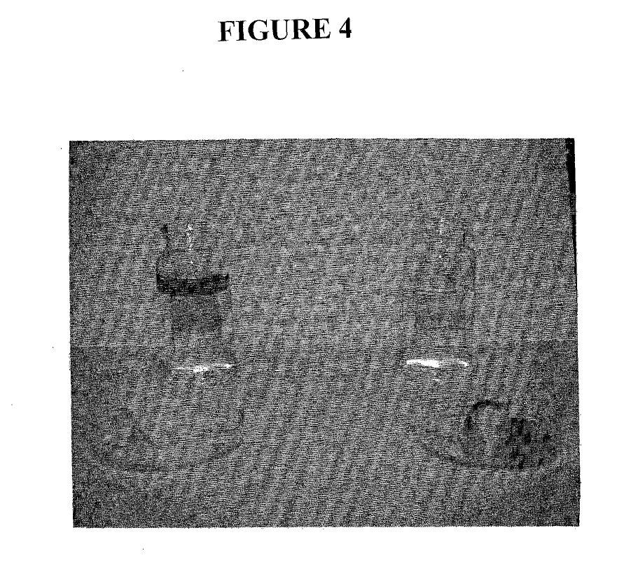

FIG. 4 is a photograph of the recovered cotton ball (in the dish in foreground on left) and the recovered cellulose acetate mat. The container in the background at left has retained all of its benzene; there is no dye in the cotton ball. At the right in FIG. 4. (in the dish in foreground) is the blue-dyed nano-fiber mat recovered from the container in the background. No dyed benzene is evident in the container.

### Example 4

### Fabrication of Nanogrids

The sol gels for the solutions were made by adding water to 1.5 g of tungsten isopropoxide (C₁₈H₄₂O₆W). The hydrolysis was done in a glove box in a controlled atmosphere and the resulting solution was mechanically agitated inside the glove box for 5 minutes. The solution was then ultrasonicated for 2 hours and then aged for 24 hours to ensure complete hydrolysis of the solution.

1.5 g of WO₃ sol-gel was mixed with 3 ml of acetic acid and 3 ml of ethanol in a nitrogen-filled glovebox. Then the mixed solution was removed from the glovebox and added to 10% wt/vol polyvinylpyrolidone PVP (Aldrich, MW˜1,300,000) in ethanol, followed by ˜30 min of ultrasonic bath. The mixture was immediately loaded into a syringe fitted with 22 gauge needle. The needle was connected to a high voltage power supply and positioned vertically 7 cm above a piece of a copper mesh (TWP Inc., 200 mesh, wire dia. 51 μm) which acts as a ground electrode.

The syringe pump was programmed to dispense 5 ml of PVP solution at a flow rate of 30 μL/min. Upon application of a high voltage (25 kV), a solution jet was formed at the needle tip. The solvent evaporated during flight and a nonwoven mat of fibers was deposited on the Cu mesh. Thermal oxidation of the composite Cu mesh-nanofibers was carried out at 500° C. for 5 h for complete calcination of PVP.

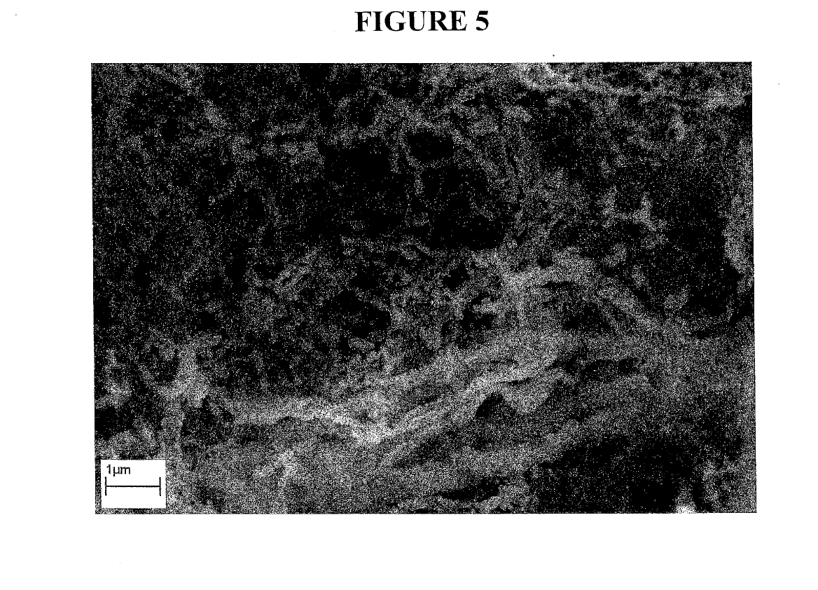

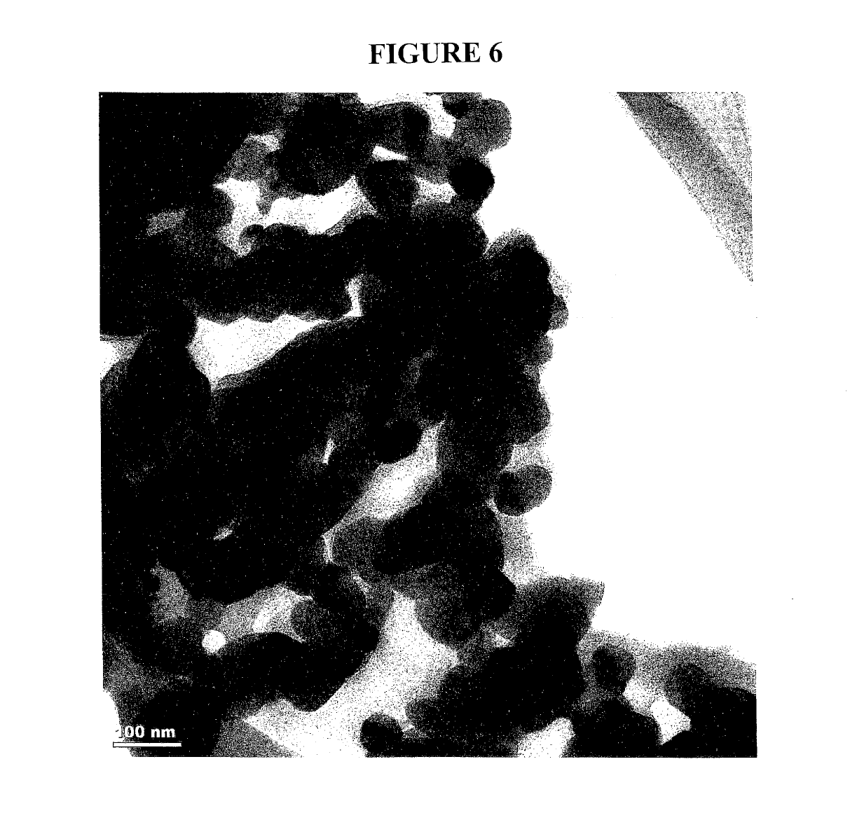

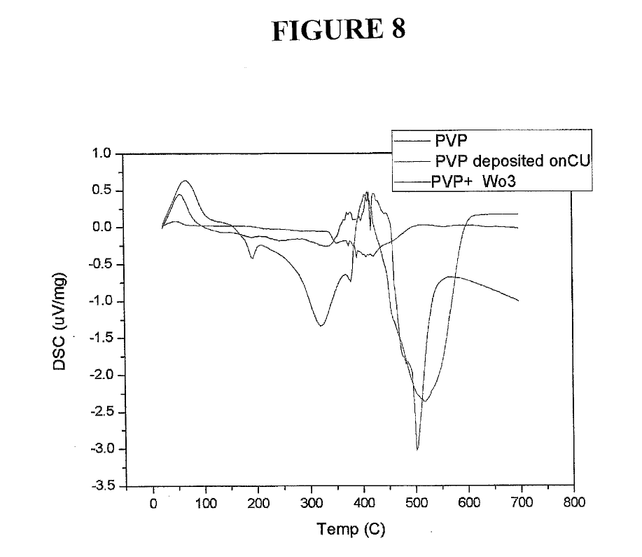

The thermal oxidation process first drives CuO crystals into the PVP nanofibers, which already contain amorphous WO₃. As the thermal process evolves, crystals of WO₃ form between and among the CuO crystals. At about 500° C., the PVP calcinates as can be seen in the differential scanning calorimeter traces shown in FIG. 8, leaving a network of “fibers” (FIG. 5) made of crystals of WO₃ in contact with crystals of CuO (FIG. 6). This network of metal oxide fibers, or “nanogrid,” now has photocatalytic properties.

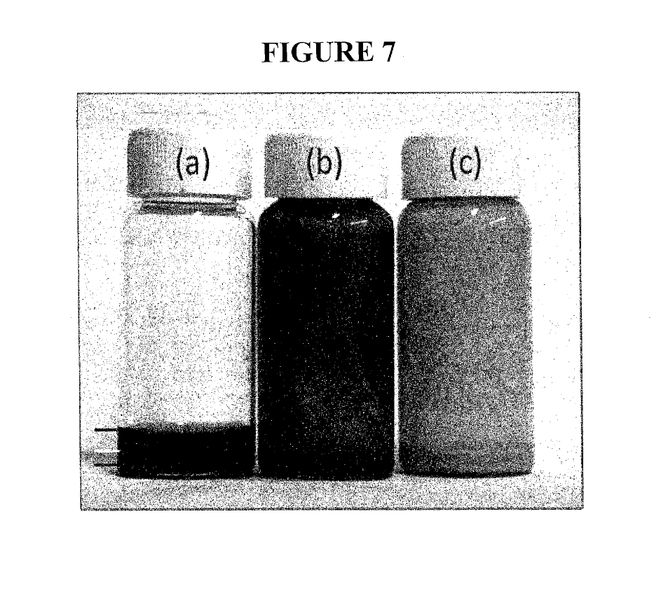

Photocatalytic degradation of benzene proceeded in a glass vial (FIG. 7). 2.6 ml of dyed benzene (dyed with unisol blue AS, Sigma-Aldrich) was poured into each of three vials, synthesized WO₃/CuO was added to vial (b) and TiO₂ (Sigma-Aldrich, Degussa p-25) to vial (c). The bottom of each vial was irradiated with light from a xenon lamp (Newport, 300 W). An AM 1.5 filter was used solar-light-simulating irradiation, respectively. After 50 h of exposure in full spectrum light, a “smoky” residue persists, but little or no benzene remains in vial (b), whereas a substantial amount of (discolored) benzene remains in vial (c).

FIG. 5 is an exemplary scanning electron microscopic image of a nanogrid. At the higher resolution provided by the transmission electron microscopic image of nanogrid elements in FIG. 6, crystals arranged within nanometers of one another can be seen.

We claim:

1. A system comprising:
a) an oil-contaminated surface of a body of water;
b) an untreated, non-woven mat comprising said nanofibers, and
c) a means of disposing said nanofibers on said surface.

2. The system of claim 1, wherein said nanofibers have a diameter of more than about 10 nm and less than about 1,000 nm.

3. The system of claim 1, wherein said nanofibers are formed by electrospinning.

4. The system of claim 3, wherein said nanofibers are electrospun under conditions such that said nanofibers adhere to a backing material or to nanofibers adherent to said backing material to create said mat.

5. The system of claim 4, wherein said mat is removably adherent to said backing material.

6. The system of claim 3, wherein said mat does not adhere to said backing material.

7. The system of claim 1, wherein said mat is more than about 50 nm thick and less than about 25 cm thick.

8. A product comprising an untreated, non-woven mat comprising nanofibers, wherein said mat further comprises an oil absorbed from an oil-contaminated surface of a body of water.

9. A method of removing an oil from a surface contaminated with oil, the method comprising disposing untreated, electrospun nanofibers comprising cellulose acetate onto said surface.

10. The method of claim 9, wherein: a) said disposing forms an untreated mat comprising said nanofibers, and b) said mat absorbs said oil.

11. The method of claim 9, wherein: a) said nanofibers are in an untreated, pre-formed mat; b) said pre-formed mat is disposed on said contaminated surface, and c) said pre-formed mat absorbs said oil.

12. The method of claim 11, wherein said pre-formed mat adheres to a backing.

13. The method of claim 9, wherein said surface comprises water.

14. The method of claim 13, wherein said water comprises a body of water.

15. The method of claim 14, wherein said body of water is sea-water.

16. The method of claim 14, wherein said body of water is fresh- or brackish water.

17. The method of claim 9, wherein said surface is on land.

18. The method of claim 9, wherein said surface is a man-made surface.

19. The method of claim 9, wherein said oil comprises an emulsion selected from the group consisting of a water-in-oil emulsion and an oil-in-water emulsion.

20. A method of recovering an oil from a surface contaminated with oil, the method comprising the steps of a) disposing an untreated, non-woven mat of untreated, electrospun nanofibers comprising cellulose acetate onto said surface to absorb said oil, creating an oil-containing mat; b) removing said oil-containing mat from said contaminated surface, and c) securing said mat in a container.

21. The method of claim 20 comprising the additional steps of d) expressing said absorbed oil from said mat, and e) isolating said expressed oil.

22. A photocatalytic nanogrid comprising a composite of at least two metal oxides.

23. The nanogrid of claim 22, wherein said metal oxides comprise crystals.

24. The nanogrid of claim 22, wherein said metal oxides comprise cupric oxide (CuO) and tungsten trioxide (WO₃).

25. The nanogrid of claim 24, wherein said CuO crystals and said WO₃ crystals are disposed in a 1:1 relationship to one another.

26. The nanogrid of claim 24 wherein said CuO crystal contacts said WO₃ crystal.

27. The nanogrid of claim 25, wherein said CuO crystals are disposed in a copper mesh.

28. The nanogrid of claim 22, wherein said composite floats on and covers a liquid surface.

29. The nanogrid of claim 28, wherein said liquid comprises an aqueous liquid.

30. The nanogrid of claim 28, wherein said liquid comprises a hydrocarbonaceous liquid.

31. The nanogrid of claim 22, further comprising an untreated, non-woven mat comprising electrospun cellulose acetate nanofibers.

32. The nanogrid of claim 31, wherein said nanofibers are electrospun onto said nanogrid.

33. The system of claim 1, wherein said mat further comprises a photocatalytic nanogrid.

34. A method of fabricating a composite comprising CuO and WO₃, said method comprising the steps of:
a) providing a solution comprising tungsten isopropoxide in water;
b) hydrolyzing said tungsten isopropoxide to create a sol-gel comprising WO₃;
c) mixing said sol-gel with acetic acid and ethanol under hypoxic conditions;
a) adding said mixture to polyvinyl pyrrolidone (PVP) in ethanol to create a WO₃-PVP-solvent mixture;
b) electrospinning said mixture, with solvent evaporation, onto a copper mesh to create a three-dimensional network of WO₃-PVP nanofibers on said copper mesh, and
f) thermally oxidizing said PVP and said mesh to create said composite.
